(19) United States
(12) Patent Application Publication
(10) Pub. No.: US 2024/0014626 A1
(43) Pub. Date: Jan. 11, 2024

(54) Erbium-Doped Optical Fiber

(71) Applicant: Huawei Technologies Co., Ltd., Shenzhen (CN)

(72) Inventors: Yehui Liu, Shenzhen (CN); Shiyi Cao, Shenzhen (CN); Jinyan Li, Wuhan (CN)

(21) Appl. No.: 18/471,930

(22) Filed: Sep. 21, 2023

Related U.S. Application Data
(63) Continuation of application No. PCT/CN2022/080269, filed on Mar. 11, 2022.

(30) Foreign Application Priority Data
Mar. 23, 2021 (CN) 202110307730.6

(51) Int. Cl. H01S 3/16; H01S 3/067

(52) U.S. Cl. CPC H01S 3/1608; H01S 3/06716

(57) ABSTRACT

An erbium-doped optical fiber includes a fiber core, where the fiber core includes erbium ions, aluminum ions, phosphorus ions, lanthanum ions, antimony ions, and silicon ions. A mass percentage of the erbium ions ranges from 0.25 percentage by weight (wt %) to 0.6 wt %, a mass percentage of the aluminum ions ranges from 3 wt % to 6 wt %, a mass percentage of the phosphorus ions ranges from 7 wt % to 16 wt %, a mass percentage of lanthanum ions ranges from 0.5 wt % to 1.2 wt %, a mass percentage of antimony ions ranges from 1 wt % to 5 wt %, and a mass percentage of silicon ions is greater than 60 wt %.

### CROSS-REFERENCE TO RELATED APPLICATIONS

This is a continuation of International Patent Application No. PCT/CN2022/080269 filed on Mar. 11, 2022, which claims priority to Chinese Patent Application No. 202110307730.6 filed on Mar. 23, 2021. The disclosures of the aforementioned applications are hereby incorporated by reference in their entireties.

### TECHNICAL FIELD

Embodiments of this disclosure relate to the field of rare-earth-doped optical fiber preparation, and in particular, to an erbium-doped optical fiber.

### BACKGROUND

Application of wavelength division multiplexing technologies improves transmission capabilities of optical fiber communication systems. However, with the development of information technology, a need for an optical fiber communication system with a larger transmission capacity is especially urgent. For the optical fiber communication system, the transmission capacity can be improved by improving a transmission bandwidth. Therefore, an erbium-doped fiber amplifier (EDFA) needs to be capable of implementing an effective gain for a signal within a larger wavelength range. As a core component of the erbium-doped fiber amplifier, an erbium-doped optical fiber needs to be capable of satisfying a higher performance indicator.

An existing erbium-doped fiber amplifier with an erbium-doped optical fiber can only implement an effective gain for a signal within a wavelength of 1610 nanometers (nm), and cannot implement an effective gain for signals with subsequent wavelengths, due to an insufficient performance indicator of the erbium-doped optical fiber used by the erbium-doped fiber amplifier.

### SUMMARY

Embodiments of this disclosure provide an erbium-doped optical fiber, to implement an effective gain for an optical signal with a larger wavelength.

A first aspect of an embodiment of this disclosure provides an erbium-doped optical fiber.

A structure of an optical fiber may be generally divided into three layers. An outermost layer of the optical fiber is a coating used for protection and strengthening, an intermediate layer is a cladding with a low refractive index, and an innermost layer is a fiber core with a high refractive index. A fiber core of the erbium-doped optical fiber in the present disclosure includes erbium (Er) ions, aluminum (Al) ions, phosphorus (P) ions, lanthanum (La) ions, antimony (Sb) ions, and silicon (Si) ions. Further, a mass percentage of the erbium ions ranges from 0.25 percentage by weight (wt %) to 0.6 wt %, a mass percentage of the aluminum ions ranges from 3 wt % to 6 wt %, a mass percentage of the phosphorus ions ranges from 7 wt % to 16 wt %, a mass percentage of the lanthanum ions ranges from 0.5 wt % to 1.2 wt %, a mass percentage of the antimony ions ranges from 1 wt % to 5 wt %, and a mass percentage of the silicon ions is greater than 60 wt %.

In this embodiment of this disclosure, ions included in the fiber core of the optical fiber and mass percentages corresponding to types of ions are limited, so that a doping concentration of the erbium ions is increased, and a radiation spectrum of the erbium ions is redshifted, thereby implementing an effective gain for an optical signal with a larger wavelength.

In a possible implementation, in the fiber core, the mass percentage of the erbium ions is 0.25 wt %, the mass percentage of the aluminum ions is 4 wt %, the mass percentage of the phosphorus ions is 7 wt %, the mass percentage of the lanthanum ions is 0.6 wt %, and the mass percentage of the antimony ions is 1 wt %.

In this embodiment of this disclosure, the mass percentages of the types of ions in the fiber core are further limited, thereby improving feasibility of the solution.

In a possible implementation, the mass percentage of the erbium ions is 0.4 wt %, the mass percentage of the aluminum ions is 5.5 wt %, the mass percentage of the phosphorus ions is 9 wt %, the mass percentage of the lanthanum ions is 0.8 wt %, and the mass percentage of the antimony ions is 1.3 wt %.

In this embodiment of this disclosure, the mass percentages of the types of ions in the fiber core are further limited, thereby improving feasibility of the solution.

In a possible implementation, the fiber core includes erbium trioxide (Er₂O₃), aluminum oxide (Al₂O₃), phosphorus pentaoxide (P₂O₅), lanthanum trioxide (La₂O₃), and antimony trioxide (Sb₂O₃). The erbium ions exist in the form of erbium trioxide, the aluminum ions exist in the form of aluminum oxide, the phosphorus ions exist in the form of phosphorus pentaoxide, the lanthanum ions exist in the form of lanthanum trioxide, and the antimony ions exist in the form of antimony trioxide.

In this embodiment of this disclosure, specific existence forms of the ions in the fiber core are limited, thereby improving feasibility of the solution.

In a possible implementation, the fiber core may further include one or more of the following elements: gallium (Ga), boron (B), germanium (Ge), fluorine (F), cerium (Ce), and gadolinium (Gd).

In a possible implementation, a diameter of the fiber core may range from 1 micrometer (m) to 20 μm.

In a possible implementation, a numerical aperture of the fiber core may range from 0.01 μm to 1.2 μm.

In a possible implementation, the erbium-doped optical fiber further includes a coating and a cladding.

A second aspect of this embodiment of this disclosure provides an erbium-doped fiber amplifier, where the erbium-doped fiber amplifier includes the erbium-doped optical fiber according to the first aspect.

In a possible implementation, the erbium-doped fiber amplifier further includes a first isolator, a second isolator, a wavelength division multiplexer, a pump laser, and an optical filter. The first isolator is connected to the wavelength division multiplexer, the pump laser is connected to the wavelength division multiplexer, the wavelength division multiplexer is connected to the erbium-doped optical fiber, the erbium-doped optical fiber is connected to the second isolator, and the second isolator is connected to the optical filter.

### BRIEF DESCRIPTION OF DRAWINGS

FIG. 1 is a schematic diagram of a principle of an optical signal gain according to an embodiment of this disclosure;

FIG. 2A is a schematic diagram of a structure of an erbium-doped fiber amplifier according to an embodiment of this disclosure;

FIG. 2B is a schematic diagram of an optical fiber communication system according to an embodiment of this disclosure;

FIG. 3 is a schematic flowchart of preparing an erbium-doped optical fiber according to an embodiment of this disclosure;

FIG. 4 is a schematic diagram of a structure of an optical fiber test apparatus according to an embodiment of this disclosure;

FIG. 5 is a schematic diagram of a test result of an erbium-doped optical fiber according to an embodiment of this disclosure;

FIG. 6 is a schematic diagram of a test result of an existing erbium-doped optical fiber; and

FIG. 7 is a schematic diagram of another test result of an erbium-doped optical fiber according to an embodiment of this disclosure.

### DESCRIPTION OF EMBODIMENTS

The following describes embodiments of this disclosure with reference to accompanying drawings. It is clear that the described embodiments are only some but not all of the embodiments of this disclosure. A person of ordinary skill in the art may learn that, with the development of technologies and emergence of new scenarios, the technical solutions provided in embodiments of this disclosure are also applicable to similar technical problems.

In the specification, claims, and accompanying drawings of this disclosure, the terms “first”, “second”, and the like are intended to distinguish between similar objects but do not necessarily indicate a specific order or sequence. It should be understood that the data used in such a way are interchangeable in appropriate circumstances, so that embodiments described herein can be implemented in other orders than the order illustrated or described herein. In addition, the terms “include”, “have”, and any other variations thereof are intended to cover a non-exclusive inclusion. For example, a process, method, system, product, or device that includes a series of steps or units is not necessarily limited to those steps or units that are clearly listed, but may include other steps or units that are not clearly listed or are inherent to such a process, method, product, or device.

An embodiment of this disclosure provides an erbium-doped optical fiber, to effectively amplify a signal with a larger wavelength. The following provides detailed descriptions.

Before the erbium-doped optical fiber in this embodiment of this disclosure is described, a working principle of an erbium-doped fiber amplifier is first described.

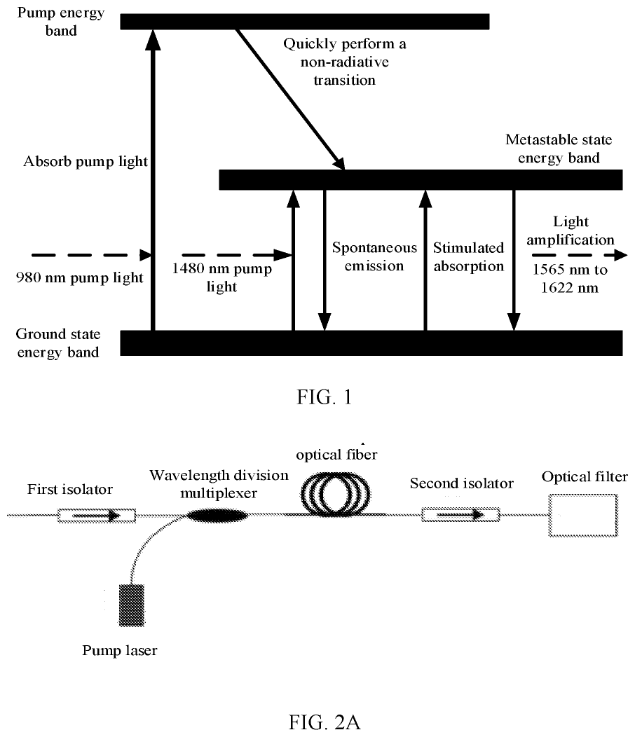

In the erbium-doped fiber amplifier, an erbium-doped optical fiber is a core component. The erbium-doped fiber amplifier provides pump light for the erbium-doped optical fiber, to excite erbium ions in a ground state to a higher energy state, resulting in reversal of quantities of particles at upper and lower energy levels. When passing through the erbium-doped optical fiber, signal light interacts with the erbium ions to generate a stimulated emission effect, thereby amplifying the signal light. In addition to the stimulated emission effect, a stimulated absorption effect and a spontaneous emission effect are also generated, where the spontaneous emission effect generates noise. Refer to FIG. 1. When pump light of 980 nm is used, erbium ions in a fiber core of an erbium-doped optical fiber transit from a ground state to a pump state. Because a life time of a carrier in the pump state is only 1 microseconds (s), electrons quickly perform a non-radiative transition to a metastable state. A life time of a carrier in the metastable state is 10 milliseconds (ms). Under continuous stimulated absorption, a quantity of particles in the metastable state accumulates, to implement distribution of reversal of quantities of particles at upper and lower energy levels. When pump light of 1480 nm is used, the erbium ions transit from the ground state to the metastable state, and then the particles are quickly redistributed in the metastable state, to implement distribution of reversal of quantities of particles at upper and lower energy levels.

However, after being amplified, the signal light needs to reach a gain value of 16 decibels (dB) to be practically useful. In a current erbium-doped fiber amplifier, only signal light with a wavelength from 1565 nm to 1610 nm can reach a sufficient gain value. Therefore, the erbium-doped fiber amplifier has specific wavelength coverage for effectively amplifying the signal light. In order to increase a gain value of signal light with a specific wavelength, a corresponding value of an emission cross-section of the erbium ions in the erbium-doped optical fiber at this wavelength needs to be increased. Further, with reference to formula 1, G(X) represents a gain value of the erbium-doped fiber amplifier for signal light with a wavelength of X, 6e(X) represents a value of an emission cross-section of the erbium ions at the wavelength of X, 6a(k) represents a value of an absorption cross-section of the erbium ions at the wavelength of X, N2 represents a quantity of upper-energy-level particles of the erbium ions, N1 represents a quantity of lower-energy-level particles of the erbium ions, and N represents a quantity of all energy-level particles of the erbium ions. It is not difficult to learn that, increasing the value of the emission cross-section of the erbium ions in the erbium-doped optical fiber at the specific wavelength may increase the gain value of the erbium-doped fiber amplifier for the signal light with the specific wavelength.

$$G ( λ ) ∝ [ δ e ( λ ) \frac{{N}_{2}}{N} - δ a ( λ ) \frac{{N}_{1}}{N} ] . \qquad Formula 1$$

The emission cross-section of the erbium ions is associated with a radiation spectrum. In the fiber core of the erbium-doped optical fiber, many factors determine features of the radiation spectrum of the erbium ions, for example, a local coordination environment of the erbium ions, types of coordination ions around the erbium ions, and symmetry of a specific position. Electronegativity of cations around the erbium ions affects intensity and a position of a peak value in the radiation spectrum, and cations with strong electronegativity improve degeneracy of electronic states of the erbium ions, so that coverage of the radiation spectrum is wider. Electronegativity of anions around the erbium ions also affects the radiation spectrum of the erbium ions. Generally, lower electronegativity of the anions around the erbium ions indicates that an absolute location of the radiation spectrum is closer to a direction of low energy.

This embodiment of this disclosure is based on introduction of highly electronegative ions including phosphorus, lanthanum, boron, antimony, and the like into the fiber core, to affect the local coordination environment of the erbium ions, improve dispersibility of the erbium ions in the fiber core, reduce a cluster effect of the erbium ions, and increase a doping concentration of the erbium ions. This implements Stark compression of the erbium ions, and redshifts the radiation spectrum of the erbium ions, thereby changing a value of the emission cross-section of the erbium ions at a specific wavelength, and finally implementing effective amplification on signal light with a wavelength of 1622 nm or higher.

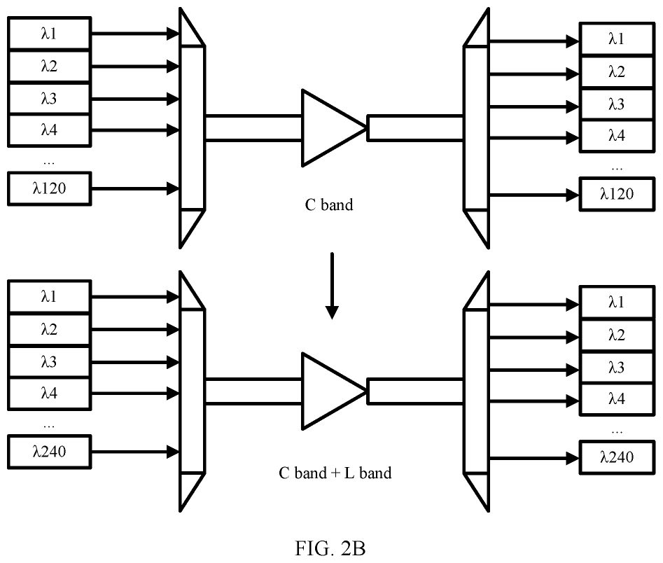

The erbium-doped optical fiber provided in this embodiment of this disclosure may be applied to an erbium-doped fiber amplifier and an optical fiber communication transmission system including an erbium-doped fiber amplifier. Refer to FIG. 2A. The erbium-doped fiber amplifier to which the erbium-doped optical fiber provided in this embodiment of this disclosure may be applied includes a first isolator, a second isolator, a wavelength division multiplexer, an erbium-doped optical fiber, an optical filter, and a pump laser, and may implement an effective gain for signal light with a wavelength of 1622 nm or higher.

Refer to FIG. 2B. In an existing optical fiber communication system, the C band may be divided into 120 wavelength channels. With the use of the erbium-doped optical fiber provided in this embodiment of this disclosure, a wavelength of signal light that can be amplified is extended. In the optical fiber communication system, 240 wavelength channels may be configured on the C band and the L band, thereby doubling a transmission capacity of the optical fiber communication transmission system. It should be noted that the quantity of wavelength channels in the optical fiber communication system shown in FIG. 2B is merely an example. In actual implementation, another quantity of wavelength channels may also be configured on the C band and the L band, which is not limited herein.

The following describes a process of preparing an erbium-doped optical fiber in an embodiment of this disclosure.

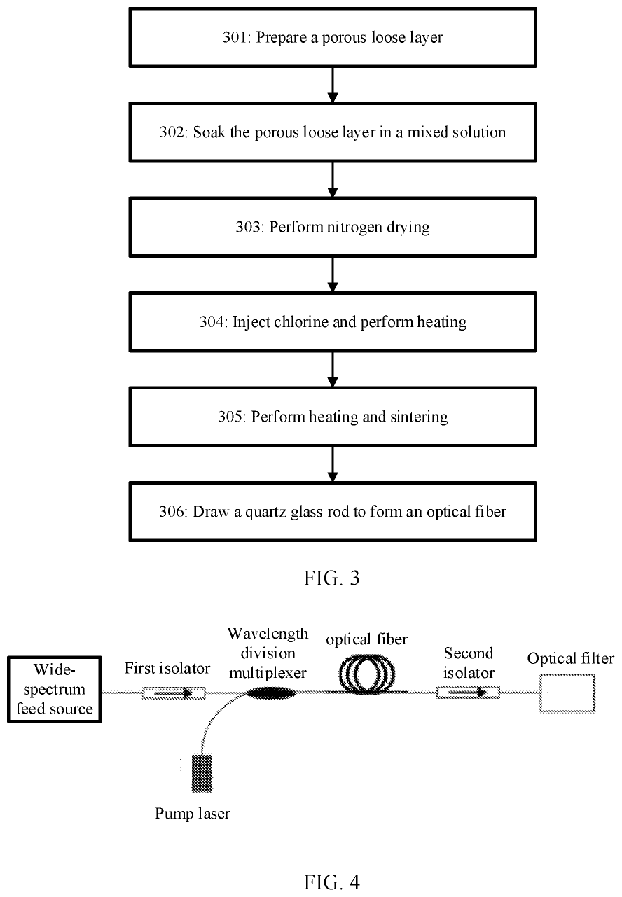

The erbium-doped optical fiber in this embodiment of this disclosure may be prepared based on modified chemical vapor deposition (MCVD). Refer to FIG. 3. The following provides detailed descriptions with steps.

301: Prepare a porous loose layer.

Raw materials including silicon tetrachloride, germanium tetrachloride, phosphorus oxychloride, high purity oxygen, sulfur hexafluoride, boron trichloride, and the like are put into a quartz tube. The quartz tube is heated by using an oxyhydrogen torch at a relatively low temperature from 1300 degrees Celsius (° C.) to 1500° C., to generate fine particles including silicon dioxide, phosphorus pentaoxide, silicon fluoride oxide, boron trioxide, and the like, which are deposited on and attached to an inner surface of the quartz tube under a thermophoresis effect and driving force of a gas inside the quartz tube, to form a white and opaque porous loose layer with a length of 150 millimeters (mm) to 300 mm.

302: Soak the porous loose layer in a mixed solution.

After the porous loose layer is prepared, the porous loose layer needs to be soaked in the mixed solution. The mixed solution is obtained by soaking rare-earth co-doped raw materials at a specific ratio in a solution of alcohol or hydrochloric acid. A process of preparing the mixed solution needs to be performed in an ultra-clean environment. The prepared mixed solution includes rare-earth co-doped ions including erbium ions, phosphorus ions, aluminum ions, lanthanum ions, antimony ions, and the like. Further, the erbium ions may be provided by one or more compounds of erbium(III) nitrate (Er(NO₃)₃), erbium(III) chloride (ErCl₃), and Er₂O₃ in the rare-earth co-doped raw materials, or may be provided by another compound of an erbium element. This is not limited herein. The aluminum ions may be provided by one or more compounds of aluminium chloride (AlCl₃), aluminium hydroxide (Al(OH)₃), aluminum nitrate (Al(NO₃)₃), and Al₂O₃ in the rare-earth co-doped raw materials, or may be provided by another compound of an aluminum element. This is not limited herein. The phosphorus ions may be provided by one or more compounds of phosphoryl chloride (POCl₃) and P₂O₅ in the rare-earth co-doped raw materials, or may be provided by another compound of a phosphorus element. This is not limited herein. The lanthanum ions may be provided by one or more compounds of La₂O₃, lanthanum(III) nitrate (La(NO₃)₃), and lanthanum chloride (LaCl₃) in the rare-earth co-doped materials, or may be provided by another compound of a lanthanum element. This is not limited herein. The antimony ions may be provided by one or more compounds of Sb₂O₃, antimony trichloride (SbCl₃), and antimony trifluoride (SbF₃), or may be provided by another compound of an antimony element. This is not limited herein. After the porous loose layer is soaked in the mixed solution, the quartz tube needs to be placed in a rotary lathe for 30 rotations per minute (r/min) rotation processing, to enable the rare-earth co-doped ions to fully penetrate the porous loose layer through adsorption.

303: Perform nitrogen drying.

After the quartz tube has been soaked in the mixed solution for 3 hours, soaking is stopped, and dry processing is performed on the quartz tube by using nitrogen.

304: Inject chlorine and perform heating.

After the quartz tube is dried, chlorine is injected into the quartz tube, and the quartz tube is heated to 600° C. to 900° C. to remove residual hydroxyl ions from the porous loose layer, thereby reducing background loss of the optical fiber.

305: Perform heating and sintering.

After the residual hydroxyl ions are removed, the quartz tube is heated to 1500° C. to 1700° C., to sinter the quartz tube into a transparent and dense quartz glass rod, and a gas including phosphorus ions is injected to perform gas phase compensation, thereby improving a doping concentration of the phosphorus ions, and finally fixing doped ions to a glass network to form a nonporous glass layer.

306: Draw the quartz glass rod to form an optical fiber.

A sintered quartz glass rod is drawn to form an optical fiber by using a rod-in-tube method, where a diameter of a fiber core ranges from 1 μm to 20 μm, and a numerical aperture of the fiber core ranges from 0.01 μm to 1.2 μm.

It should be noted that the foregoing preparation method is merely an example. In actual implementation, the erbium-doped optical fiber in this embodiment of this disclosure may be prepared by using another preparation method, provided that in a fiber core of a prepared erbium-doped optical fiber, a mass percentage of erbium ions ranges from 0.25 wt % to 0.6 wt %, a mass percentage of aluminum ions ranges from 3 wt % to 6 wt %, a mass percentage of phosphorus ions ranges from 7 wt % to 16 wt %, a mass percentage of lanthanum ions ranges from 0.5 wt % to 1.2 wt %, a mass percentage of antimony ions ranges from 1 wt % to 5 wt %, and a mass percentage of silicon ions is greater than 60 wt % (or not less than 60 wt %). A specific preparation method is not limited herein.

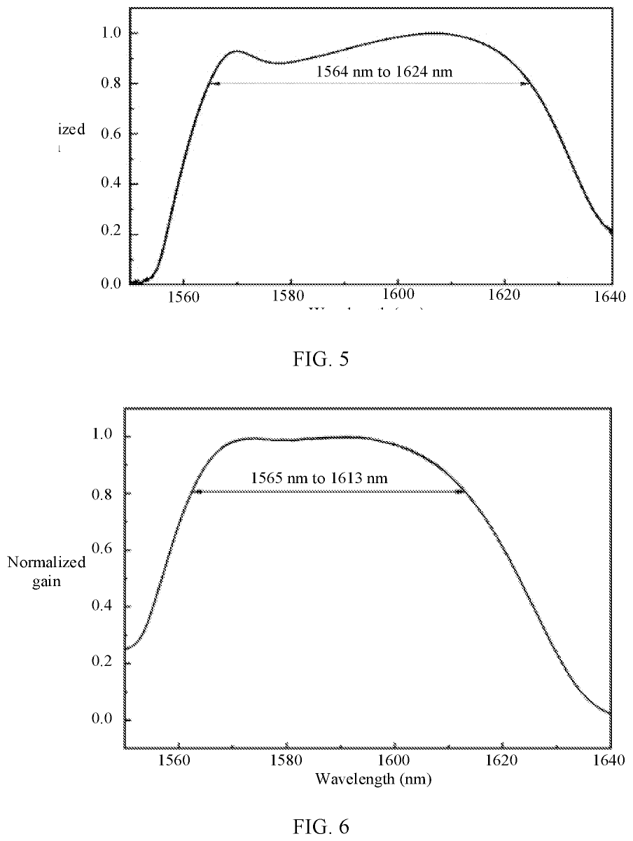

In an optional implementation, in the fiber core of the erbium-doped optical fiber, the mass percentage of the erbium ions is 0.25 wt %, the mass percentage of the aluminum ions is 4 wt %, the mass percentage of the phosphorus ions is 7 wt %, the mass percentage of the lanthanum ions is 0.6 wt %, and the mass percentage of the antimony ions is 1 wt %. It should be noted that the fiber core may further include one or more elements of gallium, boron, germanium, fluorine, cerium, and gadolinium. This is not limited herein. After the erbium-doped optical fiber in the implementation is prepared, the erbium-doped optical fiber may be tested. Further, a signal gain test may be performed on the erbium-doped optical fiber by using a test apparatus shown in FIG. 4, and a test result shown in FIG. 5 is obtained. As shown in FIG. 5, among normalized gain values, gain values of 0.8 dB and higher are gain values for effectively amplifying signal light. Correspondingly, the erbium-doped optical fiber in this embodiment of this disclosure may obtain an effective gain at 1564 nm to 1624 nm. FIG. 6 is a test result corresponding to an existing erbium-doped optical fiber. As shown in FIG. 6, a current erbium-doped optical fiber can obtain an effective gain only at 1565 nm to 1613 nm. Therefore, the erbium-doped optical fiber in this embodiment of this disclosure can implement effective amplification of signal light with a larger wavelength range.

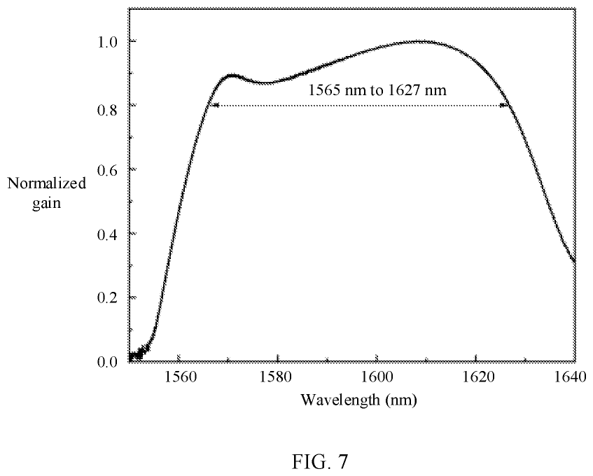

In another optional implementation, in the fiber core of the erbium-doped optical fiber, the mass percentage of the erbium ions is 0.4 wt %, the mass percentage of the aluminum ions is 5.5 wt %, the mass percentage of the phosphorus ions is 9 wt %, the mass percentage of the lanthanum ions is 0.8 wt %, and the mass percentage of the antimony ions is 1.3 wt %. It should be noted that the fiber core may further include one or more elements of gallium, boron, germanium, fluorine, cerium, and gadolinium. This is not limited herein. After the erbium-doped optical fiber in the implementation is prepared, the erbium-doped optical fiber may be tested. Further, a signal gain test may be performed on the erbium-doped optical fiber by using the test apparatus shown in FIG. 4, and a test result shown in FIG. 7 is obtained. As shown in FIG. 7, among normalized gain values, gain values of 0.8 dB and higher are gain values for effectively amplifying signal light. Correspondingly, the erbium-doped optical fiber in this embodiment of this disclosure may obtain an effective gain at 1565 nm to 1627 nm. FIG. 6 is a test result corresponding to an existing erbium-doped optical fiber. As shown in FIG. 6, a current erbium-doped optical fiber can obtain an effective gain only at 1565 nm to 1613 nm. Therefore, the erbium-doped optical fiber in this embodiment of this disclosure can implement effective amplification of signal light with a larger wavelength range.

It may be understood that the foregoing two optional implementations are merely two different examples. In actual implementation, there may be other implementations. This is not limited herein.

After the erbium-doped optical fiber in this embodiment of this disclosure is prepared, the erbium-doped optical fiber provided in this embodiment of this disclosure is described in detail above. Principles and the implementations of this disclosure are described in this specification by using specific examples. The description about the foregoing embodiments is merely provided to help understand the method and core ideas of this disclosure. In addition, a person of ordinary skill in the art can make variations and modifications in terms of the specific implementations and application scopes according to the ideas of this disclosure. In conclusion, the content of this specification shall not be construed as a limitation to this disclosure.

1. An erbium-doped optical fiber comprising;
a fiber core comprising;
erbium (Er) ions, wherein a first mass percentage of the Er ions ranges from 0.25 percentage by weight (wt %) to 0.6 wt %;
aluminum (Al) ions, wherein a second mass percentage of the Al ions ranges from 3 wt % to 6 wt %,
phosphorus (P) ions, wherein a third mass percentage of the P ions ranges from 7 wt % to 16 wt %,
lanthanum (La) ions, wherein a fourth mass percentage of the La ions ranges from 0.5 wt % to 1.2 wt %,
antimony (Sb) ions, wherein a fifth mass percentage of the Sb ions ranges from 1 wt % to 0.5 wt %; and
silicon (Si) ions, wherein a sixth mass percentage of the Si ions is greater than 60 wt %.

2. The erbium-doped optical fiber of claim 1, wherein the first mass percentage is 0.25 wt %, wherein the second mass percentage is 4 wt %, wherein the third mass percentage is 7 wt %, wherein the fourth mass percentage is 0.6 wt %, and wherein the fifth mass percentage is 1 wt %.

3. The erbium-doped optical fiber of claim 1, wherein the first mass percentage is 0.4 wt %, wherein the second mass percentage is 5.5 wt %, wherein the third mass percentage is 9 wt %, wherein the fourth mass percentage is 0.8 wt %, and wherein the fifth mass percentage is 1.3 wt %.

4. The erbium-doped optical fiber of claim 1, wherein the fiber core further comprises erbium trioxide (Er₂O₃), aluminum oxide (Al₂O₃), phosphorus pentaoxide(P₂O₅), lanthanum trioxide (La₂O₃), and antimony trioxide(Sb₂O₃).

5. The erbium-doped optical fiber of claim 4, wherein the fiber core further comprises one or more of gallium (Ga), boron (B), germanium (Ge), fluorine (F), cerium (Ce) or gadolinium (Gd).

6. The erbium-doped optical fiber of claim 1, wherein a diameter of the fiber core ranges from 1 micrometer (μm) to 20 μm.

7. The erbium-doped optical fiber of claim 6, wherein a numerical aperture of the fiber core ranges from 0.01 μm to 1.2 μm.

8. The erbium-doped optical fiber of claim 7, further comprising a coating and a cladding.

9. An erbium-doped fiber amplifier comprising:
an erbium-doped optical fiber, comprising a fiber core, wherein the fiber core comprises;
erbium (Er) ions, wherein a first mass percentage of the Er ions ranges from 0.25 percentage by weight (wt %) to 0.6 wt %;
aluminum (Al) ions, wherein a second mass percentage of the Al ions ranges from 3 wt % to 6 wt %;
phosphorus (P) ions, wherein a third mass percentage of the P ions ranges from 7 wt % to 16 wt %,
lanthanum (La) ions, wherein a fourth mass percentage of the La ions ranges from 0.5 wt %, to 1.2 wt %;
antimony (Sb) ions, wherein a fifth mass percentage of the Sb ions ranges from 1 wt % to 5 wt %; and
silicon (Si) ions, wherein a sixth mass percentage of the Si ions is greater than 60 wt %.

10. The erbium-doped fiber amplifier of claim 9, wherein
the first mass percentage is 0.25 wt %, wherein the second mass percentage is 4 wt %, wherein the third mass percentage is 7 wt %, wherein the fourth mass percentage is 0.6 wt %, and wherein the fifth mass percentage is 1 wt %.

11. The erbium-doped fiber amplifier of claim 9, wherein the first mass percentage is 0.4 wt %, wherein the second mass percentage is 5.5 wt %, wherein the third mass percentage is 9 wt %, wherein the fourth mass percentage is 0.8 wt %, and wherein the fifth mass percentage is 1.3 wt %.

12. The erbium-doped fiber amplifier of claim 9, wherein the fiber core further comprises erbium trioxide (Er₂O₃), aluminum oxide (Al₂O₃), phosphorus pentaoxide (P₂O₃), lanthanum trioxide (La₂O₃), and antimony trioxide (Sb₂O₃).

13. The erbium-doped fiber amplifier of claim 9, wherein the fiber core further comprises one or more of gallium (Ga), boron (B), germanium (Ge), fluorine (F), cerium (Ce), or gadolinium (Gd).

14. The erbium-doped fiber amplifier of claim 13, wherein a diameter of the fiber core ranges from 1 micrometer (μm) to 20 μm.

15. The erbium-doped fiber amplifier of claim 14, wherein
a numerical aperture of the fiber core ranges from 0.01 μm to 1.2 μm.

16. The erbium-doped fiber amplifier of claim 9, wherein further comprising;
a wavelength division multiplexer coupled to the erbium-doped optical fiber;
a first isolator coupled to the wavelength division multiplier;
a pump laser coupled to the wavelength division multiplexer;
an optical filter; and
a second isolator coupled to the optical filter,
wherein the erbium-doped optical fiber is coupled to the second isolator.

17. A method for preparing an erbium-doped optical fiber and comprising:
preparing a porous loose layer using silicon tetrachloride (SiCl₄), germanium tetrachloride (GeCl₄), phosphorus oxychloride (POCl₃), high purity oxygen (O), sulfur hexafluoride (SF₆), boron trichloride (BCl₃), and a quartz tube;
soaking the porous loose layer in a mixed solution;
performing nitrogen (N) drying on the quartz tube;
injecting chlorine (Cl) into and performing heating on the quartz tube;
performing heating and sintering on the quartz tube to sinter the quartz tube into a quartz glass rod; and
drawing the quartz glass rod to form the erbium-doped optical fiber.

18. The method of claim 17, wherein the mixed solution comprises rare-earth co-doped ions comprising erbium (Er) ions, phosphorus (P) ions, aluminum (Al) ions, lanthanum (La) ions, and antimony (Sb) ions.

19. The method of claim 17, wherein injecting chlorine into and performing heating on the quartz tube comprises heating the quartz tube to 600 degrees Celsius (° C.) to 900° C.

20. The method of claim 17, wherein a diameter of a fiber core of the erbium-doped optical fiber ranges from 1 micrometer (μm) to 20 μm, and wherein a numerical aperture of the fiber core ranges from 0.01 μm to 1.2 μm.
